(19) United States
(12) Patent Application Publication
(10) Pub. No.: US 2025/0277291 A1
(43) Pub. Date: Sep. 4, 2025

(54) Cemented carbide material

(71) Applicant: Betek GmbH & Co. KG, Aichhalden (DE)

(72) Inventors: Heiko Friederichs, Aichhalden (DE); Britta Philipp, Rottweil (DE); David Chmelik, Rottweil (DE); Michael Geiger, Aichhalden (DE); Ulrich Krämer, Wolfach (DE); Alexander Haller, Rottenburg (DE); Tobias Hilgert, Schramberg (DE)

(21) Appl. No.: 18/286,431

(22) PCT Filed: Apr. 21, 2022
(86) PCT No.: PCT/EP2022/060611

§ 371 Date: Oct. 11, 2023

(30) Foreign Application Priority Data
May 3, 2021 (DE) 10 2021 111 371.7

(51) Int. Cl. C22C 29/08; A01B 15/00; B28D 1/18; C22C 19/07; C22C 29/02; C22C 29/06; E02F 9/28

(52) U.S. Cl. CPC C22C 29/08; C22C 19/07; C22C 29/02; C22C 29/067; A01B 15/00; B28D 1/186; E02F 9/28

(57) ABSTRACT

The invention relates to a cemented carbide material, in particular hard metal, containing 70 to 95 wt % tungsten carbide in dispersed form, and a binder phase, wherein the binder phase comprises metallic binder material and intermetallic phase material, wherein the proportion of metallic binder material in the cemented carbide material is 2 to 28 wt %, wherein the proportion of intermetallic phase material in the cemented carbide material is 2 to 28 wt %, wherein the metallic binder material comprises Co, wherein the intermetallic phase material is formed according to the structural formula (M,Y)₃ (Al,X), wherein M=Ni, Y=Co and/or another constituent, and X=tungsten and/or another constituent. Such a cemented carbide material is characterized by particularly good wear resistance.

The invention relates to a cemented carbide material, in particular a hard metal containing 70 to 95 wt % tungsten carbide in dispersed form, and a binder phase, wherein the binder phase comprises a metallic binder material, in particular Co.

EP 2 691 198 B1 describes such a cemented carbide material, namely a hard metal body, and a method for its production. According to this known process, a powder comprising coarse-grained tungsten carbide, a superstoichiometric proportion of carbon and cobalt powder is mixed. In addition, powdered tungsten was added to the powder. The tungsten powder and the cobalt powder had a mean particle size of approx. 1 μm. The coarse grain tungsten carbide had a mean particle size of 40.8 μm.

Then this powder was ground in a ball mill and hexane and paraffin wax were added. A green compact was pressed from this mixture and subsequently this green compact was sintered. After the sintering process, the obtained cemented carbide material was subjected to a heat treatment. It was heated to 600° C. and kept at this temperature for 10 hours.

After a subsequent cooling process, the cemented carbide material was analyzed. It turned out that there are nanoparticles in the binder phase of the cemented carbide material, wherein the nanoparticles have a size smaller than 10 nm. The nanoparticles were formed by the Eta phase (Co₃W₃C) or (Co₆W₆C) or the Theta phase (Co₂W₄C). The particle size of the nanoparticles was smaller than 10 nm.

It has been shown that nanoparticles are accompanied by an enhancement of the binder phase. This can increase the hardness of the cemented carbide material. A disadvantage of these materials is the lack of thermal stability of the nanoparticles. As a result, they are only suitable to a limited extent for high-temperature applications or for applications, in which a high temperature input occurs.

During rock machining and asphalt and concrete milling, friction generates very high temperatures on the tool surface. The hard material tungsten carbide has a high hot hardness at these temperatures and is not much affected by them. However, the strength of the metallic binder drops dramatically at these temperatures. The reduced strength of the metallic binder results in increased abrasive wear and or extrusion of the binder phase as a result of the stresses imposed by the application. As a result, the hard metal can no longer hold the tungsten carbide grains.

The invention addresses the problem of providing a cemented carbide material, in particular a hard metal, which has improved wear resistance and at the same time high fracture strength.

This problem of the invention is solved by the features of claim 1. Accordingly, a cemented carbide material, in particular hard metal, containing 70 to 95 wt % tungsten carbide in dispersed form, and a binder phase, wherein the binder phase comprises metallic binder material and comprises intermetallic phase material in at least a portion of the cemented carbide material, wherein the proportion of metallic binder material in the cemented carbide material is 1 to 28 wt %, wherein the proportion of intermetallic phase material in the cemented carbide material is 1 to 28 wt %, wherein the metallic binder material comprises Co, and wherein the intermetallic phase material is formed according to the structural formula (M,Y)₃ (Al,X), wherein M=Ni, Y=Co and/or another constituent, and X=tungsten and/or another constituent, is proposed.

According to the invention, a cemented carbide material, in particular hard metal, which has a reinforced binder phase, is proposed. The binder phase is enhanced by the intermetallic phase material. The intermetallic phase material forms a crystalline intercalation in the metallic binder.

This intermetallic phase material has significantly higher strength compared to the metallic binder material, in which it is intercalated. At the surface of the cemented carbide material exposed to the wear attack, the intermetallic phase material reduces erosion or extrusion of the metallic binder material when it is used, for instance, in a ground engaging tool.

The motion of the ground engaging tool and the loosened soil material and the remaining soil material causes an abrasive and mechanical stress on the cemented carbide material. The tungsten carbide grains provide sufficient wear resistance to this wear attack. The problem in that case is the binder material, which has significantly less strength than the tungsten carbide. Because the intermetallic phase material is now integrated in the binder phase according to the invention, any rapid erosion or extrusion of the metallic binder material is prevented.

Moreover, surprisingly, the intermetallic phase material has also been shown to reinforce the internal structure of the cemented carbide material. If strong impact stresses occur, the crystals of the intermetallic phase material reduce or prevent any sliding of the tungsten carbide particles in the region of the interconnecting binder phase and thus reduce or prevent any excessive plastic deformation of the binder phase. In particular, the individual crystals of the intermetallic phase material prop each other. This has a significant advantage, particularly at high tool temperatures, because at such temperatures the strength of the cobalt in the binder phase is reduced, but the intermetallic phase material still reliably provides sufficient support effect for the binder material.

Overall, it has been shown that a significant increase in the wear resistance of the cemented carbide material can be achieved based on the solution according to the invention. Tests have shown that, for instance, the use of the cemented carbide material according to the invention in the form of a pick tip of a round pick for road-milling machines results in an increase of wear resistance of up to 50%! It has been shown that such a significant increase in wear resistance can be achieved when milling road surfaces, both asphalt and concrete.

The cemented carbide material according to the invention can be used in particular to design the working areas of tools for working, loosening, conveying and processing plant-based or mineral materials or building materials, especially in the areas of agriculture or forestry or road construction, mining or tunnel construction.

The amount of metallic binder material in the cemented carbide material according to the invention is 1 to 28 wt %, preferably 1 to 19 wt %. In so doing, apart from unavoidable impurities, all or virtually all of this metallic binder material may be formed by Co.

It is also conceivable that, in addition to unavoidable impurities, the binder material contains other constituents besides Co, in particular dissolved W, C, Ni, Al and/or Fe.

According to the invention, the intermetallic phase material is formed according to the structural formula (M,Y)₃ (Al,X), wherein M=Ni, Y=Co and/or another constituent, and X=tungsten and/or another constituent.

Preferably, at least for the majority of the crystals of the intermetallic phase material, Y=Co and X=W.

Additionally, for some or all of the crystal lattices (Al, X) may be present such that X is present in the form of both W and Mo and/or Nb and/or Ti and/or Ta and/or Cr and/or V.

In accordance with the invention, provision may be made for the binder phase to comprise two or more intermetallic phase materials or only one intermetallic phase material.

If two or more phase materials are present, the total proportion of all intermetallic phase material, according to the invention, in the cemented carbide material is still 1 to 28 wt %.

A cemented carbide material according to the invention may be characterized in that the proportion of intermetallic phase material in the binder phase is in the range from 25 wt % to 70 wt %, preferably 30 wt % to 70 wt %, more preferably in the range from 35 wt % to 60 wt %, particularly preferably in the range from 40 wt % to 50 wt %.

In other words, for instance, for a proportion of intermetallic phase material in the binder phase in the range from 30 wt % to 70 wt %, the remaining proportion of the binder phase in the range from 70 wt % to 30 wt % may be formed by the metallic binder material, which may include Co and optionally other constituents in accordance with the explanations above.

In the range of a proportion of intermetallic phase material from 30 wt % to 70 wt %, cemented carbide materials, which can be used over a wide range of applications for wear protection of components, are formed. For instance, wear protection applications can be implemented, in which the cemented carbide material can be used for hardfacing of surfaces, for instance of screen supports in high-performance screens, for instance in the processing of tar sands. Applications according to the invention, in which the surfaces of ground engaging tools are covered with the cemented carbide material, at sectionally, are also conceivable.

A cemented carbide material according to the invention may also be characterized in that the proportion of intermetallic phase material in the binder phase is in the range from 35 wt % to 60 wt %. In other words, the remaining portion of the binder phase in the range from 65 wt % to 40 wt % is formed by the metallic binder material, which may include Co and optionally other constituents according to the explanations above.

Cemented carbide materials, which can be used to manufacture sophisticated ground engaging tools, where even strong impact-type loads frequently act on the tool, are formed in the range of a proportion of intermetallic phase material from 35 wt % to 60 wt %. For instance, the bucket teeth of excavator shovels, tools of crushers, shredders, mulchers, milling machines, drills can be equipped with one or more of such cemented carbide materials.

A cemented carbide material according to the invention may also be characterized in that the proportion of intermetallic phase material in the binder phase is in the range from 40 wt % to 50 wt %. In other words, the remaining portion of the binder phase in the range from 60 wt % to 50 wt % is formed by the metallic binder material, which may include Co and optionally other constituents according to the explanations above.

Cemented carbide materials, which can be used to manufacture high-performance tools, for instance cutting elements for soil cultivation, in particular round picks, drill bits for soil augers or agricultural ground engaging tools (plow shares, cultivator tips, rotary harrow tines . . . ) are formed in the range of a proportion of intermetallic phase material from 40 wt % to 50 wt %. In this context it is conceivable, for instance, that the cutting tip of such round picks consists of a material body made of the cemented carbide material according to the invention.

According to the invention, provision may be made for the metallic binder material and/or the intermetallic phase material to comprise Nb and/or Ti and/or Ta, and/or Mo and/or V and/or Cr, wherein preferably one or more of these materials is/are present dissolved and/or as carbides in the binder phase.

However, it is also conceivable that one or more of the aforementioned constituents is/are integrated into the crystal lattice of at least part of the intermetallic phase material. For instance, the titanium atom (or another material of the aforementioned group) occupies the lattice site of Al or W in the crystal lattice of the intermetallic phase material and, like W, increases the precipitation temperature for the intermetallic phase material. On the one hand, this allows the intermetallic phase material to be precipitated more effectively, because precipitation already starts at higher temperatures and the diffusion rate is significantly higher here. Furthermore, because of this measure the sintering process can be set stoichiometrically with regard to the carbon content, as the titanium (or the other material mentioned above) takes over the role of the tungsten. On the other hand, this measure can significantly increase the high-temperature strength of the cemented carbide material.

According to one design variant of the invention, provision may be made for the carbon content to be set stoichiometrically or also sub-stoichiometrically. This measure prevents or minimizes graphite precipitation in the sintered material due to overstoichiometric carbon content. The inventors have recognized that such intercalations have a detrimental effect on the fracture strength of the cemented carbide material.

According to the invention, in particular provision may be made for the carbon content in the cemented carbide material to be in the range from:

$${C}_{stoich} ( wt \% ) - 0.003 * binder content ( wt \% ) to {C}_{stoich} ( wt \% ) - 0.012 * binder content wt \% ,$$

preferably in the range from:

$${C}_{stoich} ( wt \% ) - 0.005 * binder content ( wt \% ) to {C}_{stoich} ( wt \% ) - 0.01 * binder content wt \% .$$

According to the invention, provision may be made for the proportion of Mo and/or Nb and/or Ti and/or Ta and/or Cr and/or V in the binder phase to be ≤15 at %. In principle, the above-mentioned elements do form carbides. In the context of the invention, provision may now be made for the material composition to be chosen such that small amounts of these elements, according to the solubility product and their affinity to carbon, are dissolved in the intermetallic binder phase, i.e., they can thus be incorporated into the crystal lattice of the intermetallic phase material and/or be dissolved in the metallic binder phase. If a cemented carbide material is desired that has high toughness of the binder phase, then the carbide fraction should be kept small. The sum of these materials present should then be a proportion≤15 at %.

Advantageously, provision may be made for the coercivity H_{c}M of the cemented carbide material to be:

$${H}_{c} M [ kA / m ] > ( 1.5 + 0.04 * B ) + ( 12.5 - 0.5 * B ) / D + 4 [ kA / m ] , \\ preferably {H}_{c} M [ kA / m ] > ( 1.5 + 0.04 * B ) + ( 12.5 - 0.5 * B ) / D + 6 [ kA / m ] , \\ particularly preferably {H}_{c} M [ kA / m ] > ( 1.5 + 0.04 * B ) + ( 12.5 - 0.5 * B ) / D + 10 [ kA / m ] ,$$

wherein B is the proportion of the metallic binder phase material in the binder phase or of the metallic binder phase material plus the intermetallic phase material in the cemented carbide material in % by weight and D is the grain size of the dispersed WC determined by the linear-intercept technique according to DIN ISO 4499, Part 2.

For common hard metals, with Co in the binder phase and without intermetallic phase material, coercivity is usually used to indirectly determine the mean grain size of the WC for a given binder content. According to the invention, the intermetallic phase material causes a significant increase in coercivity. Thus, the coercivity can be indirectly evaluated as a measure of the enhancement of the binder phase due to the intercalated intermetallic phase material. The higher the coercivity, the greater the total interface between metallic binder material, intermetallic phase material and WC. A high degree of precipitated intermetallic phase material results in the individual crystals of the intermetallic phase material propping each other well in the binder phase, in particular at high temperatures (in particular at high tool temperatures).

Coercivities of the cemented carbide material H_{CM} [kA/m]>(1.5+0.04*B)+(12.5−0.5*B)/D+4 [kA/m] can be used primarily for the above-mentioned wear protection applications, for instance for hardfacing.

Coercivities of the cemented carbide material preferably H_{CM} [kA/m]>(1.5+0.04*B)+(12.5−0.5*B)/D+6 [kA/m] can be used primarily for the above-mentioned demanding ground engaging tools.

Coercivities of the cemented carbide material preferably H_{CM} [kA/m]>(1.5+0.04*B)+(12.5−0.5*B)/D+10 [kA/m] can be used primarily for the high-performance tools mentioned above.

According to one embodiment of the invention, provision may also be made for the coercivity of the cemented carbide material to be 20% higher than the coercivity of a hard metal body having the same composition and WC grain size as the cemented carbide material, wherein the binder phase is formed of metallic binder alone; however, the hard metal body does not contain any intermetallic phase material.

A hard metal body having the same composition is thus a hard metal body, containing 70 to 95 wt % tungsten carbide in dispersed form, and a binder phase, wherein the binder phase comprises metallic binder material without intermetallic phase material, wherein the proportion of metallic binder material in the cemented carbide material is 5 to 30 wt % and apart from that the binder material has the same or approximately the same composition as the binder material of the cemented carbide material according to the invention.

For instance, a cemented carbide material according to the invention, which comprises tungsten carbide in dispersed form and a cobalt binder as hard material, can be named in this context.

As this was mentioned above, the coercivity indirectly indicates the content/proportion of intermetallic phase material in the binder phase. Thus, the coercivity indirectly indicates the degree of reinforcement of the binder phase.

In the context of the invention, the cemented carbide material may be such that the hot compressive strength of the cemented carbide material at a temperature of 800° C. and a strain rate of 0.001 [1/s] is ≥1650 [MPa] and/or that the hot compressive strength of the cemented carbide material at a temperature of 800° C. and a strain rate of 0.01 [1/s] is ≥1600 [MPa](measurement for a cylindrical specimen having diameter of 8 mm and height of 12 mm). For such a cemented carbide material it is possible to produce, in particular, cutting tips for road milling picks, in which the proportion of metallic binder material in the binder phase is 5 to 7 wt % and the proportion of WC is in the range of 93 to 95 wt %, wherein preferably WC is present as coarse grains having a mean particle size in the range from 2 to 5 μm.

In the context of the invention, the advantageous effects described above are particularly pronounced in the case of coarse-grained hard metal. In a preferred embodiment of the invention, provision therefore may be made for the dispersed tungsten carbide to be present in the cemented carbide material as grains having a mean particle diameter, measured according to EN ISO 4499 Part 2, in the range from 1 to 15 μm, preferably in the range from 1.3 to 10 μm, particularly preferably in the range from 1.3 to 2.5 μm or in the range from 2.5 to 6 μm.

Preferably, provision is made for the maximum content of Fe in the binder phase to be 5% by weight and/or for other unavoidable impurities to be present in the binder material.

If provision is made for the intermetallic phase (M,Y)₃(Al,X) to have a crystal structure L1₂ (space group 221) according to ICSD (Inorganic Crystal Structure Database), then a microstructure in the binder phase results, in which the crystals of the intermetallic phases can be uniformly distributed and effectively prop each other in the metallic binder material when the cemented carbide body is subjected to heavy loads.

Preferably, for the intended use, preferably of ground machining tools, provision is made for the intermetallic phase material to have a maximum size of 1500 nm, preferably a maximum size of 1000 nm.

According to a preferred embodiment of the invention, provision may be made for the cemented carbide material to be free or as free as possible from the Eta phase and/or Al₂O₃. The inventors have recognized that the maximum proportion of the Eta phase or the maximum proportion of Al₂O₃ should not exceed 0.6 vol % based on the total cemented carbide material. If both substances are present in the cemented carbide material, it is advantageous if the total of Eta-phase material and of Al₂O₃ is at most 0.6 vol %.

The particle size of Al₂O₃ and/or of the Eta-phase material is advantageously at most 5 times the mean WC grain size, wherein the mean WC grain size and the particle size of Al₂O₃ and/or of the Eta phase material can be determined using the linear-intercept technique (according to EN ISO 4499 Part 2).

The toughness of the cemented carbide material can be negatively affected by the Eta phase or Al₂O₃. At higher Eta-phase contents, the cemented carbide material is only of limited suitability for use in demanding ground engaging tools. The same applies to Al₂O₃.

As described above, the cemented carbide material may be a hard metal having a reinforced binder phase. This enhancement occurs due to the precipitation of intermetallic phase material during cooling in the sintering process.

A nominal composition at the weighing of the raw materials of 70 to 95 wt % WC, 1 to 28 wt % metallic binder and 1 to 28 wt % intermetallic phase can be selected for the production of a hard metal according to the invention. The metallic binder may have the elements Co, and optionally Fe and/or other constituents. The intermetallic phase at weighing is Ni₃Al.

According to the invention, cemented carbide material can also be such that the binder phase has the chemical element composition specified below:

Ni>25 wt %, Al>4 wt %, the balance is made up of Co and dissolved binder constituents, for instance W and/or C,

preferably Ni>35 wt %, Al>5 wt %, the balance is made up of Co and dissolved binder constituents, for instance W and/or C,

particularly preferably Ni>40 wt %, Al>6.5 wt %, the balance is made up of Co and dissolved binder constituents, for instance W and/or C,

wherein in particular provision may be made for the ratio of the mass fractions Al to Ni to be >0.10.

According to a preferred variant of the invention, provision may be made for the proportion of oxygen in the binder phase to be ≤2 wt %, preferably ≤1.5 wt %. The inventors have recognized that it is advantageous if no Al₂O₃ is present in the binder phase or if only very small amounts of Al₂O₃ are present. This material reduces the ductility or toughness of the binder and the cemented carbide material becomes more brittle. Accordingly, Al₂O₃ weakens the binder phase and thus the strength of the cemented carbide material. If the amount of oxygen in the binder phase is minimized, as suggested, the formation of this substance will be prevented or minimized.

The problem of the invention is also solved by a cemented carbide material, in particular hard metal, containing 70 to 95 wt %, preferably containing 80 to 95 wt %, tungsten carbide in dispersed form, and a binder phase, wherein the binder phase comprises metallic binder material and, at least in a partial area of the cemented carbide material, intermetallic phase material, preferably (M, X)₃ (AL, Y) wherein M=Ni, Y=Co and/or another constituent and X=tungsten and/or another constituent, wherein the binder phase has the chemical element composition listed below:

Ni>25 wt %, Al>4 wt %, the balance is made up of Co and dissolved binder constituents, for instance W and/or C,

preferably Ni>35 wt %, Al>5 wt %, the balance is made up of Co and dissolved binder constituents, for instance W and/or C,

particularly preferably Ni>40 wt %, Al>6.5 wt %, the balance is made up of Co and dissolved binder constituents, for instance W and/or C,

wherein in particular provision may be made for the ratio of the mass fractions Al to Ni to be >0.10.

Production (with Description of Measurement Methods)

### Production:

The production method by which a cemented carbide material containing intermetallic phase material in the binder phase can be produced via a powder metallurgy process routine is described below. The latter is divided into the process steps of producing a compressible powder mixture, shaping, and finally sintering it into compact and dense cemented carbide bodies.

WC powders of various particle sizes can be used as starting materials for the production of the powder mixture, in particular coarse-grained WC having a particle size FSSS>25 μm. Starting powders for the binder phase are extra-fine cobalt powder (FSSS 1.3 μm) and nickel-aluminum powder, for instance Ni—Al powder with an aluminum content of approx. 13.3 wt %. The particle size of the Ni—Al powder is FSSS<70 μm, preferably smaller FSSS 45 μm. W metal powder (FSSS<2 μm) and lamp black are used to set and adjust a targeted carbon content. For alloying the binder phase with alloying elements, such as Ti, Ta, Mo, Nb, V, Cr, their carbide powders, or their W-containing mixed carbides having particle sizes<3 μm are used.

The powder mixture is produced according to the state of the art by wet grinding, preferably in a ball mill equipped with hard metal balls. Ethanol and hexane are used as grinding media. Other possible grinding media would be acetone or aqueous media with suitable inhibitors.

In the production of powder mixtures for cemented carbide material having binder contents>15%, a single grinding process is sufficient due to the high binder content and favored recrystallization. For binder contents up to 15%, on the other hand, a multi-stage wet grinding process is advantageous in order to effectively comminute the Ni—Al powders and to minimize the formation of oxides during the grinding process.

In the first step, the Ni—Al powder is intensively mixed with grinding fluid and coarse-grained tungsten carbide having a mean particle size FSSS>20 μm, preferably from 30 to 60 μm. If necessary, pressing aids, small quantities of alloying constituents and cobalt powder can also be added at this stage.

The grinding parameters (duration, ratio of grinding balls to grinding stock, grinding medium) and the ratio of WC to Ni—Al powder are based on the WC grain size to be set in the cemented carbide material.

In the second step, 50 to 80 wt % WC raw material(s) of defined particle size(s) is/are added at this pre-grinding stage and blended, wherein the main focus is on reducing agglomerates and obtaining as homogeneous a mixture as possible.

If the alloy adjustment and the addition of pressing aids were not performed in the first grinding step (pre-grinding stage VM), it can now be done in the second step.

The slurry obtained during wet grinding is dried according to the state of the art and converted into a powder ready for pressing. Preferably, this is done using the process of spray drying.

Forming is preferably performed directly, by axial pressing using mechanical, hydraulic or electromechanical presses.

Sintering is performed between 135° and 1550° C. in a vacuum, preferably in industrial sintering HIP furnaces, in which an inert gas inlet creates overpressure after liquid phase sintering, wherein any residual porosity can be eliminated.

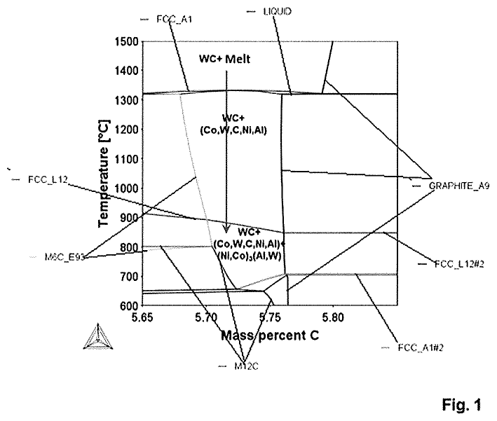

By way of example, FIG. 1 shows the WC—Co—Ni₃Al phase diagram for 3 wt % Co and 3 wt % NiAl, which illustrates the formation of these precipitates.

After solidification of the melt, initially only WC and a solid solution of Co, Ni, Al, W and C are present. Only between approx. 950 and 600° C. does the intermetallic phase material precipitate from this solid solution, wherein the intermetallic phase material is formed according to the structural formula (M,Y)₃(Al,X), wherein M=Ni, Y=Co and/or another constituent and X=tungsten and/or another constituent. A scanning electron microscope can be used to visualize these intermetallic phase materials.

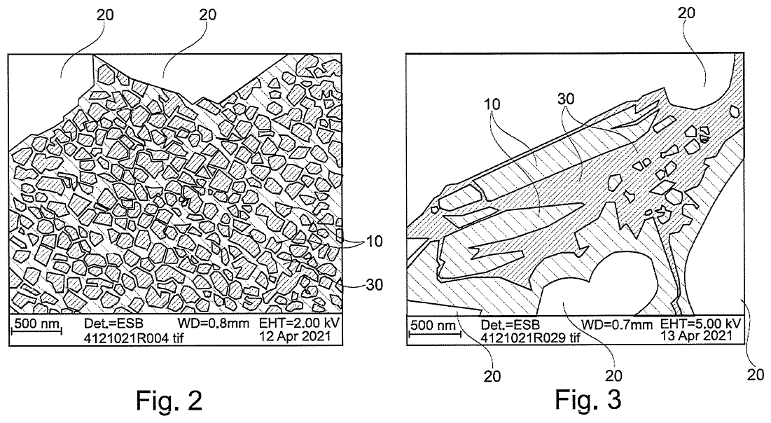

FIGS. 2 and 3 illustrate two different cemented carbide materials according to the invention, in the form of hard metals, using such scanning electron micrographs. The binder phase of such a hard metal can be clearly seen, in which the intermetallic phase material (lighter phase) 10 and the metallic binder material 30 (dark) can be identified. The WC grains 20 are bonded by the binder phase.

A uniform distribution of the intermetallic phase material in the binder phase is shown, wherein the crystals of the intermetallic phase material have a cubic shape and are preferably smaller than 1500 nm. The crystals of the intermetallic phase material (M, Y)₃(Al, X) have a crystal structure L1₂ (space group 221) in accordance with ICSD (Inorganic Crystal Structure Database).

In order to be able to easily precipitate the intermetallic phase material in the binder phase, provision may preferably be made for the (M, Y)₃(Al, X) content in the binder phase to be ≥40% and the carbon balance is set stoichiometrically or sub-stoichiometrically in that way.

It has been shown that a higher tungsten solution in the binder stabilizes the precipitation of the intermetallic phase material. This is caused by the incorporation of “Co3W” into the crystal structure of the intermetallic phase material and the shift of the precipitation range towards higher temperatures.

The elements Mo, Nb, Cr, V and especially Ti, Ta, which can be added in small amounts (<15 at % in the binder) show a similar effect.

The usable alloy quantity depends on the individual solubility product of the metal carbides. Even though these appear negligible in terms of their magnitude, surprisingly clear effects are evident that cannot be attributed to a grain-reducing effect.

Due to the increased stability and better precipitation behavior, through the addition of further elements, the proportion of intermetallic phase material in the binder can be reduced and can also be lower than 40%. Furthermore, in the presence of, for instance, Ti or Ta, the carbon balance no longer needs to be set substoichiometrically because these elements take over the role of tungsten as stabilizer.

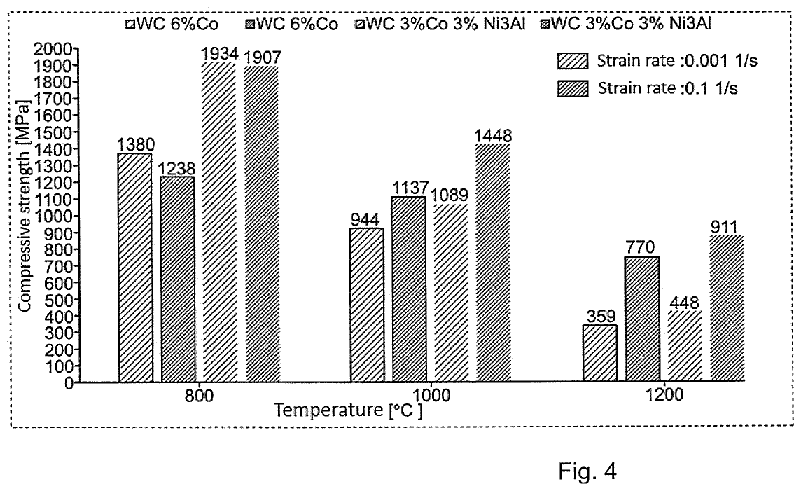

The effect of precipitation of the intermetallic phase material on high-temperature strength can be impressively demonstrated by hot compression tests. FIG. 4 shows the hot compressive strength of hard metals containing 6% binder each at different test temperature and strain rates. In particular, the intermetallic phase material increases the strength by approx. 40 to 50% at a test temperature of 800° C.

Physical quantities are determined on the cemented carbide material samples, which contribute to characterize the material and its properties.

For hard metals, the determination of the coercivity H_{cM} and the specific magnetic saturation 4 ps have been established as non-destructive testing methods.

Both measured variables are also determined for the characterization of the cemented carbide material of the invention using a Koerzimat® 1.097 by Förster.

Another parameter for characterizing the material is density, which is determined by weighing according to Archimedes' principle.

The hardness of the material is determined in accordance with the standard applicable to hard metals on metallographically prepared polished specimens. Preferably, the Vickers HV10 hardness test with a test load of 10 kp is used (ISO 3878).

Also, the porosity of the sintered material (EN ISO 4499-4 standard) and aluminum oxide particles are detected and evaluated by light microscopy on polished specimens. To estimate the volume percentages of aluminum oxide in the microstructure, comparative images of A porosity and B porosity can be used, wherein A08 and B08 are approximately equal to a volume fraction of 0.6 vol %. The Eta phase is etched with Murakami solution according to the standard (EN ISO 4499-4) for a light microscopic examination. The average WC grain sizes are determined according to EN ISO 4499-2. In so doing, SEM (scanning electron microscope) images are evaluated using the linear-intercept technique.

The proportions of the intermetallic phase in the binder and the maximum size of the precipitated particles are also determined by SEM images, but using an inlense BSE detector. For this purpose, images are taken at several locations of the sample and the evaluation is performed on a representative section by means of image processing and determination of the area fractions by tonality demarcation.

### EXAMPLES

The table below shows examples of cemented carbide bodies according to the invention. The examples shown in this table can in principle be manufactured using the same method as described above:

| Example | | Description | | | | | |
|---|---|---|---|---|---|---|---|
| 1 | | 6% binder, thereof approx. 50% intermetallic phase, raw materials without carbon | | | | | |
| | | correction | | | | | |
| 2 | | 6% binder, thereof approx. 50% intermetallic phase, addition of tungsten metal | | | | | |
| | | powder | | | | | |
| 3 | | 6% binder, thereof approx. 50% intermetallic phase, addition of carbon black | | | | | |
| 4 | | 6% binder, thereof approx. 40% intermetallic phase, raw materials without carbon | | | | | |
| | | correction | | | | | |
| 5 | | 6% binder, thereof approx. 50% intermetallic phase, addition of WTiC | | | | | |
| 6 | | 8.5% binder, thereof approx. 40% intermetallic phase, raw materials without carbon | | | | | |
| | | correction | | | | | |
| 7 | | 15% binder, thereof approx. 50% intermetallic phase, raw materials without carbon | | | | | |
| | | correction | | | | | |
| 8 | | Small series containing 6% binder, thereof approx. 50% intermetallic phase, addition | | | | | |
| | | of tungsten metal powder | | | | | |
| 9 | | Small series containing 6% binder, thereof approx. 50% intermetallic phase, without | | | | | |
| | | carbon correction | | | | | |
| 10 | | Small series containing 6% binder, thereof approx. 50% intermetallic phase, addition | | | | | |
| | | of carbon black | | | | | |
| Reference, not according | | 6% binder, cobalt only, grinding conditions similar to Examples 1 to 10 | | | | | |
| to the invention | | | | | | | |
| | | | | 6-50 | 6-50 C− | 6-50 C+ | 6-40 |
| Designation | | | | Example 1 | Example 2 | Example 3 | Example 4 |
| | Pre-grinding | Material | Size | [kg] | [kg] | [kg] | [kg] |
| | Weighted | Ni-13Al | −325 mesh | 0.120 | 0.120 | 0.120 | 0.096 |
| | sample | Co | FSSS | 0.120 | 0.120 | 0.120 | 0.144 |
| | | | 1.3 μm | | | | |
| | | WC | FSSS | 0.760 | 0.760 | 0.760 | 0.760 |
| | | | 25 μm | | | | |
| | | WTiC 50:50 | FSSS | | | | |
| | | | 1.7 μm | | | | |
| | | Total | | 1 | 1 | 1 | 1 |
| | Grinding | Grinding time | [h] | 24 | 24 | 24 | 24 |
| | parameters | Ratio of | | 5:1 | 5:1 | 5:1 | 5:1 |
| | | grinding balls | | | | | |
| | | to grinding | | | | | |
| | | stock | | | | | |
| | Grinding result | Material | | [kg] | [kg] | [kg] | [kg] |
| | Weighted | Pre-grinding | | 0.25 | 0.25 | 0.25 | 0.25 |
| | sample | Co | FSSS | | | | |
| | | | 1.3 μm | | | | |
| | | WC | FSSS | 0.75 | 0.745 | 0.75 | 0.75 |
| | | | 25 μm | | | | |
| | | W-Metal | FSSS | | 0.005 | | |
| | | | 2 μm | | | | |
| | | Carbon black | | | | 0.0003 | |
| | | Total | | 1 | 1 | 1 | 1 |
| | Grinding | Grinding time | [h] | 8 | 8 | 8 | 8 |
| | parameters | Ratio of | | 5:1 | 5:1 | 5:1 | 5:1 |
| | | grinding balls | | | | | |
| | | to grinding | | | | | |
| | | stock | | | | | |
| Sintering | Parameter(s) | Sinter HIP Vacuum Furnace System: Vacuum solvent dewaxing, vacuum | | | | | |
| | | sintering/argon partial pressure, sintering temperature 1430° C. | | | | | |
| | | 1 h + 30′ high pressure 50 bar, pressurized cooling, cooling | | | | | |
| | | time in temperature interval 900-600° approx. 40 min | | | | | |
| physical | coercive force | H_{cM} | [kA/m] | 21.9 | 25.5 | 15.1 | 11.5 |
| characteristics | spec. magn. | 4πσ | [uTm³/kg] | 5.8 | 5.1 | 6.6 | 7.1 |
| | Saturation | | | | | | |
| | Hardness | HV10 | | 1200 | 1220 | 1170 | 1160 |
| | Density | ρ | [g/cm³] | 14.83 | 14.87 | 14.82 | 14.85 |
| | Porosity | EN ISO | | <A02, B00, | <A02, B00, | <A02, B00, | <A02, B00, |
| | | 4499-4 | | C00 | C00 | C00 | C00 |
| | Grain size WC | EN ISO | | 3 | 2.9 | 3.1 | 3.2 |
| | | 4499-2 | | | | | |

| | |
|---|---|
| Hot compressive | [MPa] |
| strength* | |

| Other | Eta phase | | none | none | none | none |
|---|---|---|---|---|---|---|
| characteristics | Alumina | | none | none | none | none |
| | Binder content in | [m %] | 6 | 6 | 6 | 6 |
| | the hard metal | | | | | |
| | (weighted sample) | | | | | |
| | Proportion intermet. | [%] | 46% | 48% | 39% | 35% |
| | Phase to Binder ** | | | | | |
| | max. size of the | [nm] | <150 | <150 | 150 | <150 |
| | intermetallic phase | | | | | |

| | | | | 6-50 Ti | 8.5-40 | 15-50 | 6-50 C− S | 6-50 |
|---|---|---|---|---|---|---|---|---|
| Designation | | | | Example 5 | Example 6 | Example 7 | Example 8 | Example 9 |
| | Pre-grinding | Material | Size | [kg] | [kg] | [kg] | [kg] | [kg] |
| | Weighted | Ni-13Al | −325 mesh | 0.120 | 0.240 | 0.240 | 9.000 | 9.000 |
| | sample | Co | FSSS | 0.120 | | | 9.000 | 9.000 |
| | | | 1.3 μm | | | | | |
| | | WC | FSSS | 0.740 | 0.760 | 0.760 | 57.000 | 57.000 |
| | | | 25 μm | | | | | |
| | | WTiC 50:50 | FSSS | 0.020 | | | | |
| | | | 1.7 μm | | | | | |
| | | Total | | 1 | 1 | 1 | 75 | 75 |
| | Grinding | Grinding time | | [h] | 24 | 24 | 24 | 7 |
| | parameters | Ratio of grinding balls | | 5:1 | 5:1 | 5:1 | 6.7:1 | 6.7:1 |
| | | to grinding stock | | | | | | |
| | Grinding result | Material | | [kg] | [kg] | [kg] | [kg] | [kg] |
| | Weighted | Pre-grinding | | 0.25 | 0.142 | 0.313 | 37.5 | 37.5 |
| | sample | Co | FSSS | | 0.051 | 0.075 | | |
| | | | 1.3 μm | | | | | |
| | | WC | FSSS | 0.75 | 0.807 | 0.612 | 111.7 | 112.5 |
| | | | 25 μm | | | | | |
| | | W-Metal | FSSS | | | | 0.8 | |
| | | | 2 μm | | | | | |
| | | Carbon | | | | | | |
| | | black | | | | | | |
| | | Total | | 1 | 1 | 1 | 150 | 150 |
| | Grinding | Grinding | [h] | 8 | 8 | 8 | 6 | 7 |
| | parameters | time | | | | | | |
| | | Ratio of grinding balls | | 5:1 | 5:1 | 5:1 | 3.3:1 | 3.3:1 |
| | | to grinding stock | | | | | | |
| Sintering | Parameter(s) | Sinter HIP Vacuum Furnace System: Vacuum solvent dewaxing, vacuum | | | | | | |
| | | sintering/argon partial pressure, sintering temperature 1430° C. | | | | | | |
| | | 1 h + 30′ high pressure 50 bar, pressurized cooling, cooling | | | | | | |
| | | time in temperature interval 900-600° approx. 40 min | | | | | | |
| physical | coercive force | H_{cM} | [kA/m] | 25.3 | 11.7 | 20.4 | 28.7 | 18.5-21.8 |
| characteristics | spec. magn. | 4πσ | [uTm³/kg] | 5.4 | 10.0 | 13.9 | 4.9 | 4.6-4.9 |
| | Saturation | | | | | | | |
| | Hardness | HV10 | | 1205 | 1080 | 910 | 1250 | 1170 |
| | Density | ρ | [g/cm³] | 14.83 | 14.53 | 13.75 | 14.82 | 14.80 |
| | Porosity | EN ISO | | <A02, | <A02, | <A02, | <A02, | <A02, |
| | | 4499-4 | | B00, C00 | B00, C00 | B00, C00 | B00, C00 | B00, C00 |
| | Grain size WC | EN ISO | | 2.9 | 3 | 3.1 | 2.4 | 3.1 |
| | | 4499-2 | | | | | | |

| | | |
|---|---|---|
| Hot compressive | [MPa] | 1930 |
| strength* | | |

| Other | Eta phase | | none | none | none | none | none |
|---|---|---|---|---|---|---|---|
| characteristics | Alumina | | none | none | <0.10 vol. % | <0.05 vol. % | <0.05 vol. % |
| | Binder content in | [m %] | 6 | 8.5 | 15 | 6 | 6 |
| | the hard metal | | | | | | |
| | (weighted sample) | | | | | | |
| | Proportion intermet. | [%] | 49% | 35% | 47% | 52% | 42% |
| | Phase to Binder ** | | | | | | |
| | max. size of the | [nm] | <150 | <150 | <150 | <100 | <100 |
| | intermetallic phase | | | | | | |

| | | | | 6-50 C+ | 6-0 |
|---|---|---|---|---|---|
| Designation | | | | Example 10 | Reference |
| | Pre-grinding | Material | Size | [kg] | [kg] |
| | Weighted sample | Ni-13Al | −325 mesh | 9.000 | |
| | | Co | FSSS | 9.000 | 0.240 |
| | | | 1.3 μm | | |
| | | WC | FSSS | 57.000 | 0.760 |
| | | | 25 μm | | |
| | | WTiC 50:50 | FSSS | 0 | |
| | | | 1.7 μm | | |
| | | Total | | 75.000 | 1 |
| | Grinding | Grinding time | | [h] | 7 |
| | parameters | Ratio of grinding balls | | 6.7:1 | 5:1 |
| | | to grinding stock | | | |
| | Grinding result | Material | | [kg] | [kg] |
| | Weighted sample | Pre-grinding | | 37.5 | 0.25 |
| | | Co | FSSS | | |
| | | | 1.3 μm | | |
| | | WC | FSSS | 112.5 | 0.75 |
| | | | 25 μm | | |
| | | W-Metal | FSSS | | |
| | | | 2 μm | | |
| | | Carbon | | 0.042 | |
| | | black | | | |
| | | Total | | 1 | 1 |
| | Grinding parameters | Grinding time | | [h] | 8 |
| | | Ratio of grinding balls | | 3.3:1 | 5:1 |
| | | to grinding stock | | | |
| Sintering | Parameter(s) | Sinter HIP Vacuum Furnace System: Vacuum solvent dewaxing, vacuum | | | |
| | | sintering/argon partial pressure, sintering temperature 1430° C. | | | |
| | | 1 h + 30′ high pressure 50 bar, pressurized cooling, cooling | | | |
| | | time in temperature interval 900-600° approx. 40 min | | | |
| physical | coercive force | H_{cM} | [kA/m] | 16.9-18.9 | 5.2 |
| characteristics | spec. magn. | 4πσ | [uTm³/kg] | | |
| | Saturation | | | | |
| | Hardness | HV10 | | 1160 | 1150 |
| | Density | ρ | [g/cm³] | 14.83 | 14.76 |
| | Porosity | EN ISO | | <A02, | <A02, |
| | | 4499-4 | | B00, C00 | B00, C00 |
| | Grain size WC | EN ISO | | 2.9 | 3.1 |
| | | 4499-2 | | | |

| | |
|---|---|
| Hot compressive | [MPa] |
| strength* | |

| Other | Eta phase | | none | |
|---|---|---|---|---|
| characteristics | Alumina | | <0.05 vol. % | |
| | Binder content in | [m %] | 6 | 6 |
| | the hard metal | | | |
| | (weighted sample) | | | |
| | Proportion intermet. | [%] | 49% | 39% |
| | Phase to Binder ** | | | |
| | max. size of the | [nm] | <150 | <100 |
| | intermetallic phase | | | |

*non-standardized comparative test using specimens ø8 × 12 mm, test temperature 800° C., strain rate 0.001 1/s
** Evaluation of area proportions based on tonality demarcation in the micrograph. Calibration using solution-annealed samples isothermally aged at 700°/10 h of the same composition.

1-22. (canceled)

23. A cemented carbide material, comprising:
a dispersed tungsten carbide phase in an amount ranging from 70 wt % to 95 wt % of the cemented carbide material; and
a binder phase comprising a metallic binder material in an amount ranging from 1 wt % to 28 wt % of the cemented carbide material and an intermetallic phase material in an amount ranging from 1 wt % to 28 wt % of the cemented carbide material,
wherein the metallic binder material comprises Co,
wherein the intermetallic phase material has a structural formula of (M,Y)₃ (Al,X), wherein M is Ni, Y comprises Co, and X comprises W.

24. The cemented carbide material of claim 23, wherein Y further comprises Fe, Mo, Nb, Ti, Ta, Cr, V, or a combination thereof and X further comprises Mo, Nb, Ti, Ta, Cr, V, or a combination thereof.

25. The cemented carbide material of claim 23, wherein the intermetallic phase material is a first intermetallic phase material, and wherein the binder phase further comprises a second intermetallic phase material.

26. The cemented carbide material of claim 23, wherein the intermetallic phase material provides 25 wt % to 70 wt % of the binder phase.

27. The cemented carbide material of claim 23, wherein the (M,Y)₃ (Al,X) provides at least 30 wt % of the binder phase.

28. The cemented carbide material of claim 24, wherein the binder phase contains 15 at % or less combined Nb, Ti, Ta, Mo, V, and Cr content.

29. The cemented carbide material of claim 24, wherein the Mo, Nb, Ti, Ta, Cr, V, or the combination thereof is dissolved in the binder phase, present as a carbide formed in the binder phase, or both dissolved in the binder phase and present as a carbide in the binder phase.

30. The cemented carbide material of claim 23, wherein a carbon content of the cemented carbide material is set stoichiometrically such that the carbon content of the cemented carbide material ranges from C_{stoich} (wt %)−0.003*binder content (wt %) to C_{stoich} (wt %)−0.012*binder content wt %.

31. The cemented carbide material of claim 23, wherein a coercivity (H_{c}M) of the cemented carbide material is greater than (1.5+0.04*B)+(12.5−0.5*B)/D+4 [kA/m], wherein B is a proportion of the binder phase in the cemented carbide material, in wt %, and D is an average grain size of the dispersed tungsten carbide phase.

32. The cemented carbide material of claim 23, wherein cemented carbide material has a strength of 1650 MPa or greater at a temperature of 800° C. when tested at a strain rate of 0.001 1/s, or a strength of 1600 MPa or greater at a temperature of 800° C. when tested at a strain rate of 0.01 1/s.

33. The cemented carbide material of claim 23, wherein the dispersed tungsten carbide phase comprises grains having a mean diameter ranging from 1 μm to 15 μm.

34. The cemented carbide material of claim 23, wherein the binder phase comprises less than 5 wt % Fe.

35. The cemented carbide material of claim 23, wherein the intermetallic phase material has an L1₂ structure.

36. The cemented carbide material of claim 23, wherein the intermetallic phase material has a maximum particle size of 1500 nm.

37. The cemented carbide material of claim 23, further comprising an Eta phase, an Al₂O₃ phase, or a combination thereof, wherein a combined content of the Eta phase and Al₂O₃ phase of the cemented carbide material is 0.6 vol % or less of the cemented carbide material.

38. The cemented carbide material of claim 37, wherein an average particle size of the Eta phase and the Al₂O₃ phase is no greater than 5 times an average grain size of the dispersed tungsten carbide phase.

39. The cemented carbide material of claim 23, wherein the binder phase comprises more than 25 wt % Ni, more than 4 wt % Al, and a balance comprising Co and elements dissolved in the Co.

40. The cemented carbide material of claim 23, wherein the binder phase comprises no more than 2 wt % O.

41. The cemented carbide material of claim 23, wherein at most half of the dispersed tungsten carbide phase is formed as fully sintered crystals having a prismatic grain shape.

42. A cemented carbide material comprising:
tungsten carbide in an amount ranging from 70 wt % to 95 wt %; and
a binder phase comprising a metallic binder material and an intermetallic phase material,
wherein the binder phase comprises more than 25 wt % Ni, more than 4 wt % Al, and Co.

43. The cemented carbide material of claim 42, wherein a ratio of Al to Ni in the cemented carbide material is greater than 0.1.

44. The cemented carbide material of claim 42, where the binder material further comprises W, C, or a combination thereof and the W, the C, or the combination thereof is dissolved in the Co.

45. The cemented carbide material of claim 44, wherein the intermetallic phase has a structural formula of (M,Y)₃ (Al,X), wherein M is Ni, Y is Co or another constituent, and X is W or another constituent.

46. The cemented carbide material of claim 42, wherein at least half of the tungsten carbide phase is formed as crystals which are not fully sintered and do not have a prismatic grain shape.

47. A ground engaging tool for a machine, comprising:
a tool body; and
a cemented carbide material according to claim 23 attached to the tool body,
wherein the machine is a soil cultivation machine, a road construction machine, an agricultural soil cultivation machine, a road milling machine, or a stabilizer, and
wherein the cemented carbide material is attached to the tool body by soldering, brazing, or gluing.
